(19) United States
(12) Patent Application Publication
(10) Pub. No.: US 2025/0040480 A1
(43) Pub. Date: Feb. 6, 2025

(54) ISOLATED HARVESTER ROTARY CUTTERBAR WITH GROUND LOAD SENSING

(71) Applicant: AGCO Corporation, Duluth, GA (US)

(72) Inventor: Nick Williams, Hesston, KS (US)

(21) Appl. No.: 18/778,452

(22) Filed: Jul. 19, 2024

Related U.S. Application Data
(60) Provisional application No. 63/516,601, filed on Jul. 31, 2023.

(51) Int. Cl. A01D 34/74; A01D 34/00; A01D 34/82; A01D 101/00

(52) U.S. Cl. CPC A01D 34/74; A01D 34/006; A01D 34/82; A01D 2101/00

(57) ABSTRACT

A header assembly of a windrower has a cutter bar pivotably mounted on a header framework so as to pivot about a cutterbar fulcrum. Cutterbed modules are arranged in series and pivotably attached to the header framework to form a cutterbar fulcrum. An elastomeric isolator is located between the each cutterbed module and the header framework. A controller receives input from a header pitch cylinder to calculate a point of ground engagement for the cutter bar. The controller is also configured to receive input from a load cell and use a distance between the cutterbar fulcrum and the calculated point of ground engagement and a distance between the load cell and the cutterbar fulcrum to calculate a ground force and compare the calculated ground force to a desired force.

### CROSS-REFERENCE TO RELATED APPLICATION

This application claims the benefit of the filing date of U.S. Provisional Patent Application 63/516,601, “Isolated Harvester Rotary Cutterbar with Ground Load Sensing,” filed Jul. 31, 2023, the entire disclosure of which is incorporated herein by reference.

### BACKGROUND OF THE INVENTION

### Field

The present invention relates to systems and methods for cutting plant material, and more particularly, systems and methods for maintaining floatation forces on a harvesting header within desired parameters as plant material is harvested.

### Description of Related Art

A windrower (or swather or mower) is an agricultural machine used in hay and forage production configured to cut plant material growing in a field and deposit the cut plant material in windrows (or swaths) on the field to dry. An example windrower is the Massey Ferguson WR235 self-propelled mower. The crop is transported to the rear of the header and forming shields form a windrow of the crop between the tires or tracks of the machine for natural dry down of the crop. Once the cut plant material is properly dry, a baler is passed through the field to form the harvested material into bales. The cut plant material is then baled for easier transport, storage, and use. An example baler is the Massey Ferguson LB2200 large square baler.

The windrower carries a header assembly with a cutting mechanism to cut the plant material. Rotary headers used with windrowers typically include a modular cutterbar which is rigidly attached to a fabricated frame by a plurality of fasteners. An example rotary header is the Massey Ferguson 9300 Series Disc Header. The cutterbar converts and transmits input power from one axis into several vertically oriented, synchronized, output axes which propel the rotary discs that cut crop. The frame supports the cutterbed and all other components and subsystems of the header. When operating the rotary header, it is desirable to have the ability to enable the plurality of rotary discs on the cutterbar that cut and convey crop to follow the ground over changing terrain without having the cutterbar gouging or digging into the soil. Header components are normally set so that the cutterbar contacts the ground such that 425-475 N (95-105 lbf) is required to lift the header at either end. Windrower operators typically have adjusted the header to have the desired ground engagement by physically lifting one end of the header to see if it feels like there is sufficient downpressure.

In order to improve efficiencies, windrowers have been designed to drive faster through the field with headers having increasingly larger cutterbars. There are significant challenges with manufacturing fabricated frames to attach to large cutterbeds and yield an acceptable service life. Relating to attachment, the tolerances inherent with welded frame structures often exceed that which is required for assembly of the cutterbed. Relating to service life, the stress concentrations inherent with welded structures limit the life of the frame in service. Additionally, the rigid connection of the cutterbed to the frame results in the transmission of all ground loads from the cutterbed into the frame. This has become a greater issue as harvesters have become more powerful and can operate at faster speeds due to improved windrower handling and suspension.

This background discussion is intended to provide information related to the present invention which is not necessarily prior art.

### BRIEF SUMMARY

One aspect of the invention is directed to a windrower that includes a windrower frame having left and right header lift arms. The windrower also includes a header floatation cylinder configured to adjust the positioning of the header lift arms by causing the header lift arms to pivot about a header lift arm fulcrum. A header assembly is mounted on the header lift arms, the header assembly having a header framework pivotably connected to the header lift arms and a header pitch cylinder connected between the header framework and the windrower frame, where extension of the header pitch cylinder causes the header framework to pivot about a header fulcrum to adjust the pitch of the header assembly with respect to the windrower frame. The header pitch cylinder has a position sensor configured to determine a position of the header pitch cylinder. The header assembly includes a cutter bar pivotably mounted on the header framework so as to pivot about a cutterbar fulcrum, the cutter bar includes a plurality of rotary cutters, each of the plurality of rotary cutters synchronized to rotate about a vertically axis. The header assembly has a plurality of cutterbed modules, where each rotary cutter of the plurality of rotary cutters is mounted on a respective cutterbed module such that the cutterbed modules are arranged in series to form the cutter bar. Each cutterbed module is pivotably attached to the header framework with a pivotable module mounting mechanism that at least partially forms the cutterbar fulcrum, and where each cutterbed module is fixed to adjacent cutterbed modules with a linking mechanism forming a rigid connection such that the plurality of cutterbed modules combine to form a rigid body. An elastomeric isolator is located in the module mounting mechanism between the each cutterbed module and the header framework. The header assembly has at least one load cell located between the header framework and a reaction arm. A controller is configured to receive input from position sensor of the header pitch cylinder and calculate a point of ground engagement for the cutter bar. The controller is also configured to receive input from the at least one load cell and use a distance between the cutterbar fulcrum and the calculated point of ground engagement and a distance between the load cell and the cutterbar fulcrum to calculate a ground force and compare the calculated ground force to a desired force.

These and other features and advantages of this invention are described in, or are apparent from, the following detailed description of various exemplary embodiments of the systems and methods according to this invention.

### BRIEF DESCRIPTION OF THE SEVERAL VIEWS OF THE DRAWINGS

To easily identify the discussion of any particular element or act, the most significant

digit or digits in a reference number refer to the figure number in which that element is first introduced.

FIG. 1 illustrates side view of a windrower carrying a header assembly;

FIG. 2 illustrates a perspective view of a portion of the frame of the windrower and header assembly of FIG. 1;

FIG. 3 illustrates a side view of the frame of the windrower and header assembly of FIG. 2;

FIG. 4 illustrates an enlarged perspective view of a portion of the header assembly of FIG. 2;

FIG. 5 illustrates a perspective view of cutterbed module of the header assembly of FIG. 2;

FIG. 6 illustrates a side view of the frame of the windrower and header assembly of FIG. 2;

FIG. 7 illustrates a block diagram of an embodiment of an example control system;

FIG. 8 illustrates is a block diagram of an embodiment of an example controller used in the control system of FIG. 7;

FIG. 9 illustrates a flow diagram that illustrates an embodiment of an example header floatation method; and

FIG. 10 illustrates a flow diagram that illustrates an embodiment of an example header floatation method.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description. Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience and are determined by standing at the rear of the machine facing in its normal direction of travel. Furthermore, the various components shown or described herein for any specific application of this invention can be varied or altered as anticipated by this invention and the practice of a specific application of any element may already by widely known or used in the art by persons skilled in the art and each will likewise not therefore be discussed in significant detail.

As used herein, the singular forms following “a,” “an,” and “the” are intended to include the plural forms as well, unless the context clearly indicates otherwise. As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded. As used herein, the term “configured” refers to a size, shape, material composition, and arrangement of one or more of at least one structure and at least one apparatus facilitating operation of one or more of the structure and the apparatus in a predetermined way.

As used herein, any relational term, such as “first,” “second,” “top,” “bottom,” “upper,” “lower,” “above,” “beneath,” “side,” etc., is used for clarity and convenience in understanding the disclosure and accompanying drawings, and does not connote or depend on any specific preference or order, except where the context clearly indicates otherwise.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.). As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

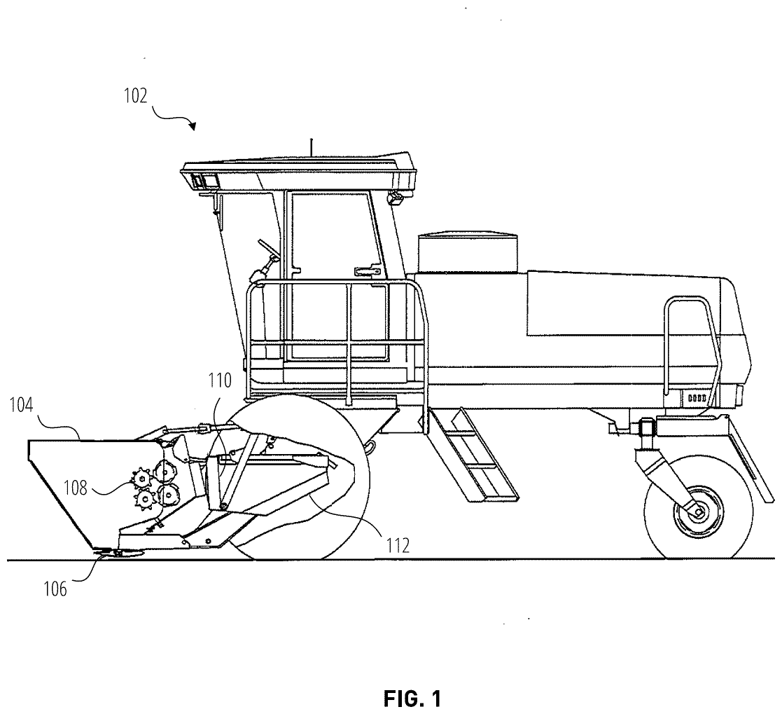

Referring to FIG. 1, an example windrower 102 is shown into which embodiments of the present invention may be incorporated. Broadly, the windrower 102 may be configured to move over a field, cut plant material, and deposit the cut plant material in windows on the field. The windrower 102 may generally include a header assembly 104, the header assembly 104 having a cutting mechanism 106, conditioning rollers 108, a swathboard 110, and forming shields 112. The cutting mechanism 106 may be configured to cut the plant material and includes cutting elements as will be described below. The conditioning rollers 108 may be configured to condition (e.g., crush, macerate) the cut plant material, which facilitates drying.

The swathboard 110 is positionable to assist in directing the conditioned plant material back to the ground and shape the windrows (especially to have a generally wider width when the swathboard 110 is lowered for maximum contact with the flow of plant material). The forming shields 112 are positionable to further assist in directing the conditioned plant material back to the ground and shape the windrows (especially to have a generally narrower width when the swathboard 110 is raised to allow the flow of plant material to reach the forming shields 112). Thus, the cutting mechanism 106 cuts the plant material at a particular cut height, the conditioning rollers 108 condition the cut plant material, and the swathboard 110 and forming shields 112 direct the conditioned plant material back to the ground and shape the windrows. The conditioning rollers 108, the swathboard 110 and the forming shields 112 may be of conventional design and are known to those skilled in the art, so need not be described in further detail.

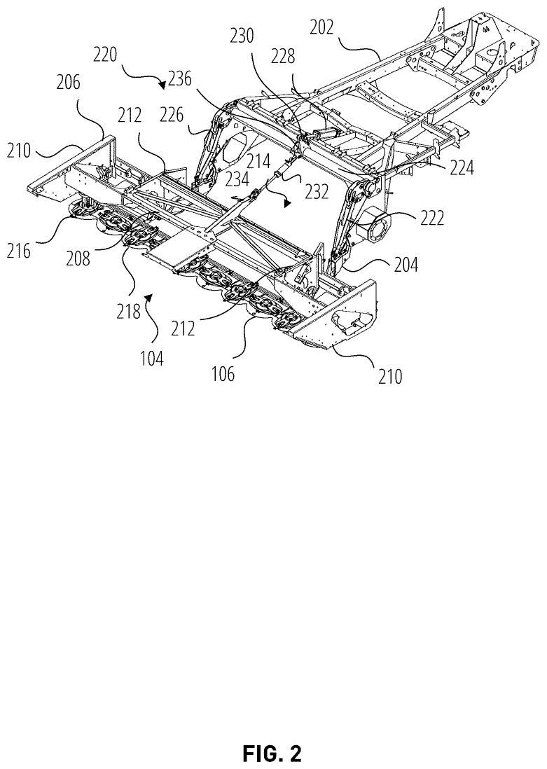

Referring now to FIG. 2, the windrower 102 has a windrower frame 202 that receives a pair of header lift arm 204 at a front end of the windrower frame 202. The header assembly 104 has a framework 206 that mounts to forward ends of the header lift arms 204. The framework 206 of the header assembly 104 includes cross members 208 supported at opposite ends by side plates 210. A pair of upright middle supports 212 support the cross members 208 and define therebetween the front boundary of a discharge opening 214 through which cut crop passes as it moves rearwardly through the header assembly 104.

The laterally extending cutting mechanism 106, in the form of a low profile, rotary style cutter bar 216, is located at the front of the header framework 206 for severing crop from the ground as the windrower 102 moves across a field. The illustrated cutter bar 216 includes a series of rotary cutters 218 spaced laterally across the path of travel of the windrower 102 with each rotary cutter 218 being rotatable about its own upright axis. While the illustrated embodiment has ten rotary cutters 218, a larger or smaller number of rotary cutters 218 may be provided. The rotary cutters 218 are rotatably supported on an elongated, flat gear case (not shown) extending the length of the cutter bar 216. As is known in the art, the gear case may contain a train of flat spur gears that are operably engaged with one another and thus serve to distribute driving power between one another, although other forms of power distribution means may be used within the gear case (e.g., shafts and bevel gears, belts and pulleys, or chains and sprockets).

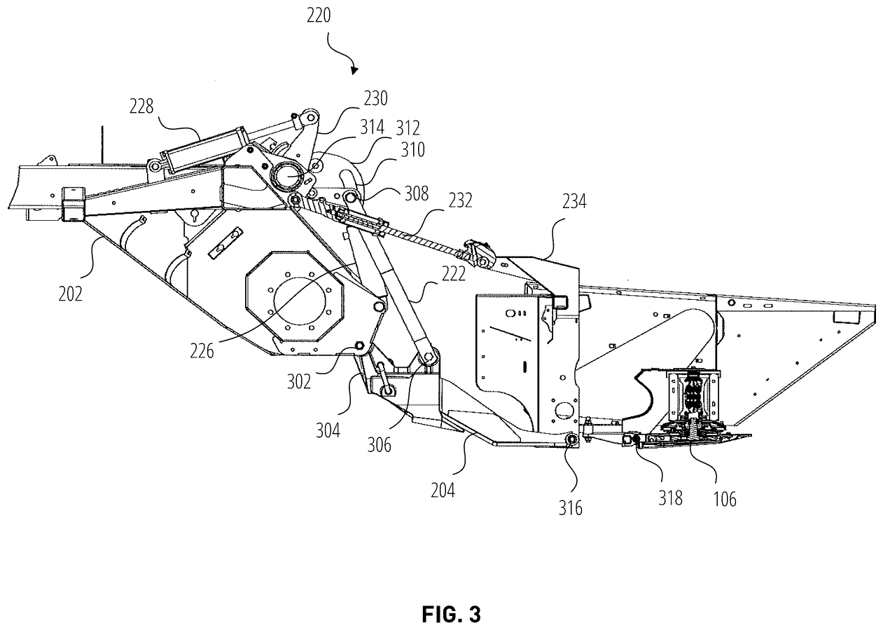

The windrower 102 has a header adjustment linkage 220 configured to control the height and pitch of the header assembly 104 relative to the windrower frame 202. Turning also now to FIG. 3, each header lift arm 204 is attached to the windrower frame 202 so as to pivot about a header lift arm fulcrum 302 located at a rear of receivers 304. The header lift arms 204 are configured to move relative to the windrower frame 202 to adjust the floatation of the header assembly 104, i.e., the amount of header weight that is transferred to the ground. Typically, windrower operators have adjusted header components so that the cutterbar contacts the ground such that about 100 lbf is required to lift either end of the header off the ground. Each side of the header adjustment linkage 220 includes a linkage bar 222 having a lower end that connects to the header lift arm 204 at connection point 306. A cam 308 is connected at an upper end of the linkage bar 222. The cam 308 is configured to ride in a cam slot 310 formed in a plate 312 that connects to a rock shaft 224 mounted on the windrower frame 202. The cam 308 is also attached to one end of a header floatation cylinder 226. The other end of the header floatation cylinder 226 is attached to the windrower frame 202. Extension and contraction of the header floatation cylinder 226 causes the cam 308 to ride in the cam slot 310, thereby causing the linkage bar 222 to adjust the positioning of the header lift arm 204 by causing the header lift arm 204 to pivot about the header lift arm fulcrum 302. Pivoting the header lift arms 204 controls the floatation of the header assembly 104.

Additionally in the illustrated embodiment, the rock shaft 224 mounted on the windrower frame 202 may be rotated by a header lift cylinder 228 about pivot 314. The header lift cylinder 228 connects to the rock shaft 224 with a crank 230 such that operation of the header lift cylinder 228 controls the rotational position of the rock shaft 224. Rotation of the rock shaft 224 causes the plates 312 mounted thereon to rotate, thereby enabling the header assembly 104 to be lifted off the ground.

The header framework 206 is also configured to pivot relative to the header lift arms 204 about a header fulcrum 316 to adjust the pitch of the header assembly 104. A header pitch cylinder 232 is connected between a center arm 234 of the header framework 206 and a brace 236 on the windrower frame 202. Extension of the header pitch cylinder 232 causes the header framework 206 to pivot about the header fulcrum 316, thereby adjusting the pitch of the header assembly 104 with respect to the windrower frame 202. The cutter bar 216 is also pivotably mounted on the header framework 206 so as to pivot about a cutterbar fulcrum 318 as will be described below.

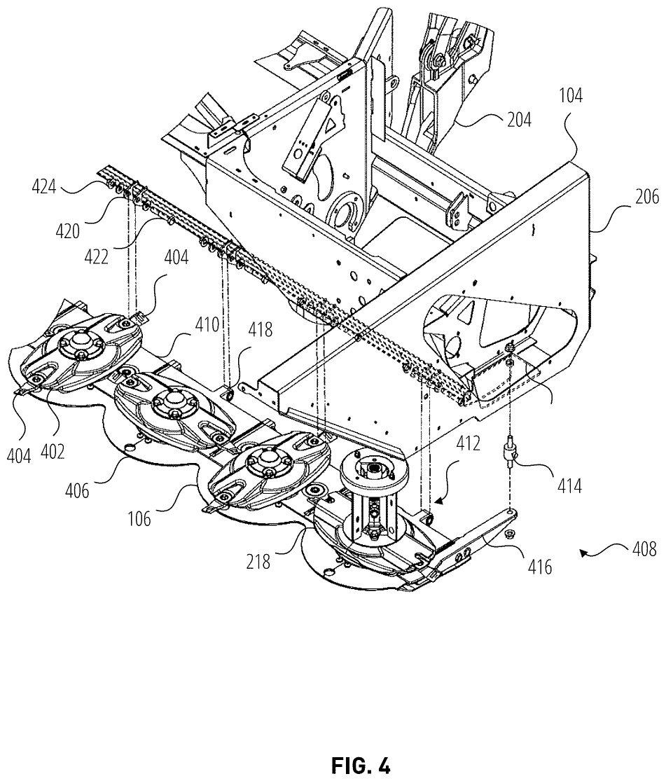

It will be appreciated that all of the rotary cutters 218 on the cutter bar 216 may be substantially similar in construction. As perhaps best shown in FIG. 4, each of the rotary cutters 218 may include a generally elliptical, metal knife carrier 402, and a pair of free-swinging knives 404 at opposite ends of the knife carrier 402, as well understood by those of ordinary skill in the art. Each of the rotary cutters 218 is ninety degrees out of phase with respect to the adjacent cutters, inasmuch as the circular paths of travel of the knives 404 of adjacent cutters overlap one another and are appropriately out of phase in order to avoid striking each other. Due to the positive mechanical drive connection between the rotary cutters 218 through the gearcase, the rotary cutters 218 remain properly synchronized with one another. The rotating knives 404 of the rotary cutters 218 cooperatively present a substantially planar cutting zone, within which crop material is severed from the ground. The illustrated rotary cutters 218 are of the same general arrangement as that disclosed in U.S. Pat. No. 5,463,852 entitled “Wide Cut Harvester having Rotary Cutter Bed,” assigned to the assignee of the present invention, which is hereby incorporated by reference in its entirety herein. The cutter bar 216 receives a series of replaceable rock guards 406 such as would be known in the art. The rock guards 406 are the desired wear components that contact the ground, and thus need to be periodically replaced.

The windrower 102 has a floatation system 408 configured to determine and manage the forces acting on the header assembly 104 and the windrower 102 resulting from the cutter bar 216 contacting the ground as the windrower 102 moves across the field. In the illustrated embodiment, each rotary cutter 218 is mounted on a cutterbed module 410 such that a plurality of cutterbed modules 410 arranged in series form the cutter bar 216. Each cutterbed module 410 is pivotably attached to the header framework 206 of the header assembly 104. Each cutterbed module 410 interfaces with the header framework 206 with a pivotable module mounting mechanism 412 that at least partially forms the cutterbar fulcrum 318 about which the cutter bar 216 pivots relative to the header framework 206.

The floatation system 408 includes a load cell 414 located between the header framework 206 and a reaction arm 416 extending rearwardly from the cutter bar 216. In the illustrated embodiment, the cutter bar 216 has two reaction arms 416, one outboard the end cutterbed module 410 on each end of the cutter bar 216, with a respective load cell 414 mounted on the aft end of each of the reaction arms 416. Add statement regarding use of additional reaction arms and load cells.

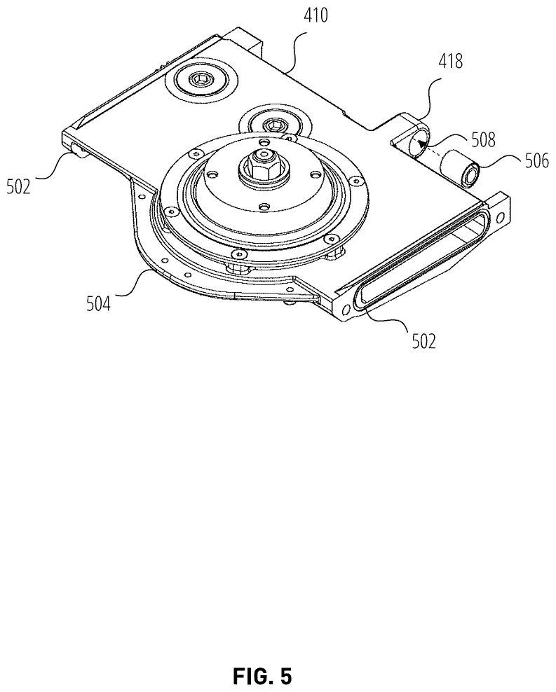

Turning also now to FIG. 5, in one embodiment, the module mounting mechanism 412 includes a collar 418 on a rear portion of each cutterbed module 410 that interfaces with an associated collar bracket 420 extending from the header framework 206. Desirably, the collar 418 is fastened to the collar bracket 420 with a suitable bolt/screw 422 and nut 424. However, one skilled in the art will understand that the collar 418 may extend from the header framework 206 and the collar bracket 420 may be positioned on the cutterbed module 410. Other pivoting connections may be used using sound engineering judgment to mount the cutterbed modules 410 on the header framework 206 such that the cutterbed modules 410 are able to pivot relative to the header framework 206 about the cutterbar fulcrum 318.

Cutterbed modules 410 in the series of modules are fixed to adjacent cutterbed modules 410 with a linking mechanism 502 forming a rigid connection such that the series of individual cutterbed modules 410 that collectively form the cutter bar 216 form a rigid body that provides the stable platform needed for the gear train components that connect and drive all the rotary cutters 218 along the cutter bar 216. The linking mechanism 502 may include suitable fasteners and fastener tabs at the connecting ends of the cutterbed module 410 such that the adjacent modules pivot about the cutterbar fulcrum 318 as a single body. A forward portion 504 of the cutterbed module 410 receives the replaceable rock guard 406 such as would be known in the art.

As best seen in FIG. 5, a plurality of elastomeric isolators 506 are installed in the module mounting mechanism 412 at the interface between the cutterbed modules 410 and the header framework 206 to isolate the connection between the cutter bar 216 and the header framework 206. In the illustrated embodiment, the collar 418 of each cutterbed module 410 receives a cylindrical isolator 506 that fits within an opening 508 formed by the collar 418 such that the isolator 506 provides an elastomeric medium between the collar 418 and the pins 422 that attach the collar 418 to the collar bracket 420.

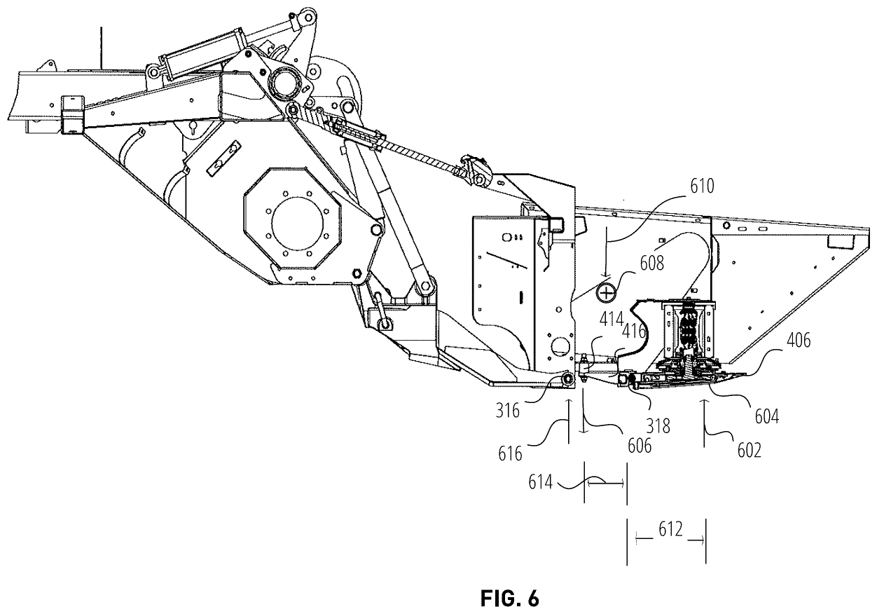

Turning now to FIG. 6, as the windrower 102 moves across the field with a portion of the weight of the header assembly 104 borne by the ground, a ground force 602 acts upon the cutter bar 216 at a point of ground engagement 604 where the rock guards 406 contact the ground. Due to the placement of the load cells 414 and the additional degree of freedom of the cutter bar 216 created by the inclusion of the isolators 506, the load cells 414 measure a load cell force 606 that is proportional to a vertical component of the ground force 602 induced on the cutter bar 216. The floatation system 408 is configured to calculate the ground force 602 and determine if the ground force 602 is within a desired range such that there is sufficient contact of the header assembly 104 with the ground to properly harvest the crop, but not so great so as to cause undue wear and damage to the header assembly 104.

Some values use by the floatation system 408 are fixed properties of the header assembly 104, specifically a header center of gravity 608, weight of header 610 and measurements based on the fixed geometry of the header framework 206. The floatation system 408 also uses the position of the header pitch cylinder 232. It is well known in the art to that the position of cylinders may be determined using suitable sensors or other measurement devices. Since cylinder position sensors are well known in the art, specifics relating to the construction and operation of these sensors need not be discussed herein. Using the position of the header pitch cylinder 232, the pitch of the cutter bar 216 is determined. With this pitch information, the point of ground engagement 604 of the cutter bar 216 may be calculated.

Using the load cell force 606 and a distance 612 between the cutterbar fulcrum 318 and the calculated point of ground engagement 604 and the distance 614 between the load cell 414 and the cutterbar fulcrum 318, the floatation system 408 calculates the ground force 602. The calculated ground force 602 is then compared to the desired force and the pressure in the floatation cylinders 226 is varied, increasingly or decreasingly, until the desired value is achieved.

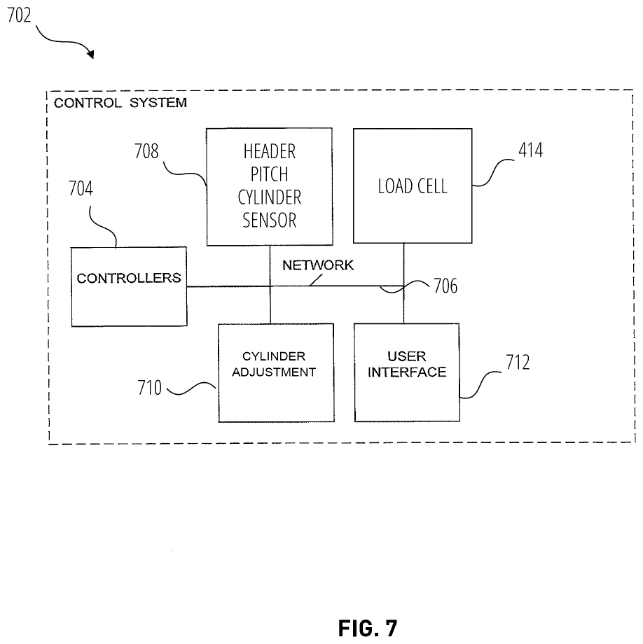

Attention is now also directed to FIG. 7, which illustrates an embodiment of an example control system 702 used for providing control and management of the floatation system 408. It should be appreciated within the context of the present disclosure that some embodiments of the control system 702 may include additional components or fewer or different components, and that the example depicted in FIG. 7 is merely illustrative of one embodiment, among others. Further, though depicted as residing entirely within the windrower 102, in some embodiments, the control system 702 may be distributed among several locations. For instance, functionality may reside all or at least partly at a remote computing device, such as a server that is coupled to the control system components over one or more wireless networks (e.g., in wireless communication with the windrower 102 via a radio frequency (RF) and/or cellular modems residing in the windrower 102). The data from the load cell 414 may be measured continuously and transmitted to the control system 702 where it is filtered and compared to an acceptable range set by the manufacturer or operator. The result of the comparison can either be communicated to the operator via a monitor or used in a closed-loop control system in which the hydraulic flotation pressure of the header lift cylinders 228 which lifts or lowers the header assembly 104 is increased or decreased by the control system 702 to reduce or increase the ground load on the cutter bar 216. This enables reduced loads on the windrower frame 202 and header framework 206 by controlling ground load transmission.

In the depicted embodiment, a controller 704 is coupled via one or more networks, such as network 706 (e.g., a CAN network or other network, such as a network in conformance to the ISO 11783 standard, also referred to as “Isobus”), to the load cell 414, to cylinder position sensors 708 of the header pitch cylinder 232, one or more mechanisms for cylinder adjustment 710, and a user interface 712. The cylinder position sensors 708 may be embodied as contact (e.g., electromechanical sensors, such as position sensors, strain gauges, pressure sensors, etc.) and non-contact type sensors (e.g., photo-electric, inductive, capacitive, ultrasonic, etc.), all of which comprise known technology. The user interface 712 may include one or any combination of a keyboard, mouse, touch-type or non-touch-type display device, joystick and/or other devices that enable input and/or output by an operator. The control system 702 may include one or more additional components, such as a wireless network interface module for wireless communication among other devices of the windrower 102 or other communication devices located remote and/or external from the windrower 102. The wireless network interface module may work in conjunction with communication software (e.g., including browser software) in the controller 704, or as part of another controller coupled to the network and dedicated as a gateway for wireless communications to and from the network, as should be appreciated by one having ordinary skill in the art.

In one embodiment, the controller 704 is configured to receive and process information from the load cells 414 and communicate instructions (e.g., ground force 602 or floatation force 616 values) to the user interface 712 based on the input of information. In some embodiments, the controller 704 may provide feedback of any automatic adjustment in flotation settings to the operator via the user interface 712.

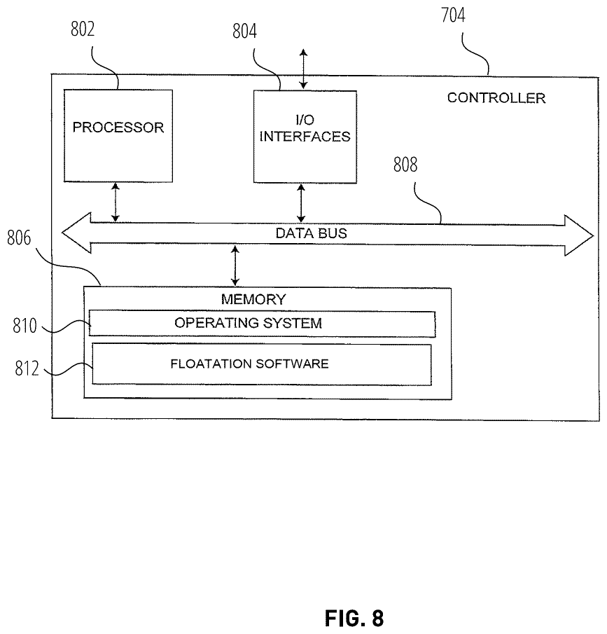

FIG. 8 further illustrates an example embodiment of the controller 704. One having ordinary skill in the art should appreciate in the context of the present disclosure that the example controller 704 is merely illustrative, and that some embodiments of controllers may comprise fewer or additional components, and/or some of the functionality associated with the various components depicted in FIG. 8 may be combined, or further distributed among additional modules, in some embodiments. It should be appreciated that, though described in the context of residing in the windrower 102, in some embodiments, the controller 704, or all or a portion of its corresponding functionality, may be implemented in a computing device or system located external to the windrower 102. Referring to FIG. 8, with continued reference to FIG. 7, the controller 704 or electronic control unit (ECU) is depicted in this example as a computer but may be embodied as a programmable logic controller (PLC), field programmable gate array (FPGA), application specific integrated circuit (ASIC), among other devices. It should be appreciated that certain well-known components of computers are omitted here to avoid obfuscating relevant features of the controller 704. In one embodiment, the controller 704 comprises one or more processors (also referred to herein as processor units or processing units), such as processor 802, input/output (I/O) interface(s) 804, and memory 806, all coupled to one or more data busses, such as data bus 808.

The memory 806 may include any one or a combination of volatile memory elements (random-access memory RAM, such as DRAM, and SRAM, etc.) and nonvolatile memory elements (e.g., ROM, Flash, hard drive, EPROM, EEPROM, CDROM, etc.). In the embodiment depicted in FIG. 8, the memory 806 comprises an operating system 810 and floatation software 812. It should be appreciated that in some embodiments, additional or fewer software modules (e.g., combined functionality) may be deployed in the memory 806 or additional memory.

The floatation software 812 receives sensor input from the load cell 414 and the cylinder sensor 708 for the header pitch cylinder 232 and processes the input to derive the ground force 602 or floatation force 616 values to communicate to the user interface 712. The floatation software 812 may compare the values received from the sensor input in a look up table (e.g., stored in memory 806) that associates the parameters to a respective flotation value. In some embodiments, the parameters are used in a formula that the floatation software 812 computes to derive a flotation value. The floatation value may be based on a moving average (or other statistical values) of prior sensor input (with the window of the moving average defined by a predetermined time and/or distance traveled by the windrower 102, FIG. 1), or continually updated in finer increments of time (e.g., as sensor input is received) in some embodiments.

Execution of the floatation software 812 may be implemented by the processor 802 under the management and/or control of the operating system 810. The processor 802 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 704.

When certain embodiments of the controller 704 are implemented at least in part with software (including firmware), as depicted in FIG. 8, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program for use by or in connection with a computer-related system or method.

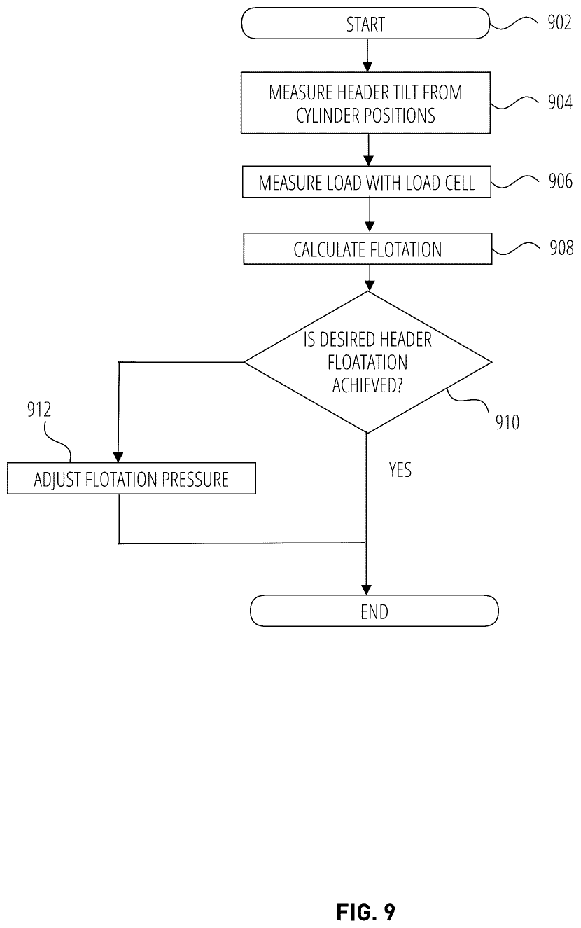

In view of the above description, it should be appreciated that one embodiment of a header floatation method 902, depicted in FIG. 9 (and implemented in one embodiment by the floatation software 812), comprises measuring header pitch using sensor data from the header pitch cylinder 232 at step 904; measuring the load cell force 606 with the load cell 414 at step 906, and calculating flotation at step 908. The method then determines if desired header floatation is achieved at step 910, and based on the determination, causing an adjustment to the header floatation by adjusting the header floatation cylinders 226 at step 912.

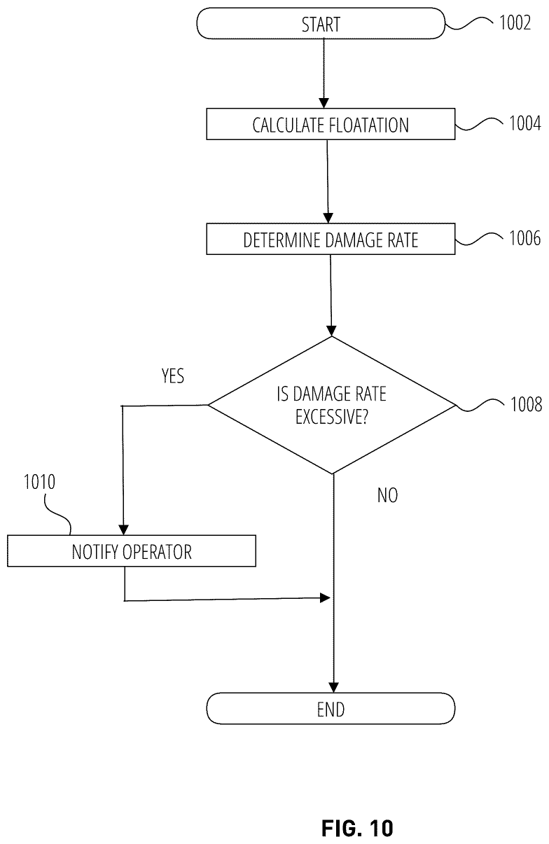

A second method 1002 monitors header floatation in terms of the mean, amplitude, and frequency of the ground load. This data could then be used in a lookup chart and a damage rate assessed. If excessive, this would be communicated to the operator along with recommended operational adjustments (i.e.: reduce speed, reduce ground load, etc.). Method 1002 is depicted in FIG. 10 (and implemented in one embodiment by the floatation software 812), comprises calculating header floatation, such as with the method 902, at step 1004; determining a damage rate of the header assembly 104 and windrower 102 based on the current header floatation values at step 1006, determining if the damage rate is excessive at step 1008. The method then notifies the operator of an excessive damage rate at step 1010.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A windrower comprising:
a windrower frame having left and right header lift arms;
a header floatation cylinder configured to adjust the positioning of the header lift arms by causing the header lift arms to pivot about a header lift arm fulcrum;
a header assembly mounted on the header lift arms, the header assembly comprising:
a header framework pivotably connected to the header lift arms;
a header pitch cylinder is connected between the header framework and the windrower frame, wherein extension of the header pitch cylinder causes the header framework to pivot about a header fulcrum to adjust the pitch of the header assembly with respect to the windrower frame, wherein the header pitch cylinder has a position sensor configured to determine a position of the header pitch cylinder;
a cutter bar pivotably mounted on the header framework so as to pivot about a cutterbar fulcrum, the cutter bar comprising:
a plurality of rotary cutters, each of the plurality of rotary cutters synchronized to rotate about a vertically axis;
a plurality of cutterbed modules, wherein each rotary cutter of the plurality of rotary cutters is mounted on a respective cutterbed module of the plurality of cutterbed modules such that the cutterbed modules are arranged in series to form the cutter bar, wherein each cutterbed module is pivotably attached to the header framework with a pivotable module mounting mechanism that at least partially forms the cutterbar fulcrum, and wherein each cutterbed module is fixed to adjacent cutterbed modules with a linking mechanism forming a rigid connection such that the plurality of cutterbed modules combine to form a rigid body, and wherein an elastomeric isolator is located in the module mounting mechanism between the each cutterbed module and the header framework;
at least one reaction arm;
at least one load cell located between the header framework and a reaction arm; and
a controller configured to receive input from position sensor of the header pitch cylinder and calculate a point of ground engagement for the cutter bar, the controller also configured to receive input from the at least one load cell and use a distance between the cutterbar fulcrum and the calculated point of ground engagement and a distance between the load cell and the cutterbar fulcrum to calculate a ground force and compare the calculated ground force to a desired force.

2. The windrower of claim 1 wherein the module mounting mechanism includes a collar on a rear portion of each cutterbed module that interfaces with an associated collar bracket extending from the header framework, wherein the collar is fastened to the collar bracket with a suitable fastener and nut.

3. The windrower of claim 2 wherein the elastomeric isolator comprises a cylindrical member that fits within an opening formed by the collar such that the isolator provides an elastomeric medium between the collar and the fastener that attaches the collar to the collar bracket.

4. The windrower of claim 1 the cutter bar has two reaction arms, one outboard the end cutterbed module on each end of the cutter bar, with a respective load cell mounted on the aft end of each of the reaction arms.

5. The windrower of claim 1 the linking mechanism comprises at least one fastener connecting ends of adjacent cutterbed modules such that adjacent modules pivot about the cutterbar fulcrum as a single body.

6. The windrower of claim 1 wherein a forward portion of each cutterbed module receives a replaceable rock guard.

7. The windrower of claim 1 wherein each of the rotary cutters comprises an elliptical, metal knife carrier, and a pair of free swinging knives at opposite ends of the knife carrier, wherein each of plurality of rotary cutters is ninety degrees out of phase with respect to the adjacent rotary cutter such that circular paths of travel of the knives of adjacent cutters overlap one another and are out of phase so as to avoid striking each other.
